(19) United States
(12) Patent Application Publication
(10) Pub. No.: US 2017/0027021 A1
(43) Pub. Date: Jan. 26, 2017

(54) TEMPERATURE CONTROLLED BIN FOR STORING SUNGLASSES

(71) Applicant: FORD GLOBAL TECHNOLOGIES, LLC, Dearborn, MI (US)

(72) Inventors: Scott Holmes Dunham, Redford, MI (US); Stuart C. Salter, White Lake, MI (US); Elizabeth Cleary Johnston Tengler, Grosse Pointe Park, MI (US); James J. Surman, Clinton Township, MI (US)

(21) Appl. No.: 14/805,008

(22) Filed: Jul. 21, 2015

(51) Int. Cl. H05B 1/02; H05B 3/02

(52) U.S. Cl. CPC H05B 1/0236; H05B 1/0275; H05B 3/026

(57) ABSTRACT

A temperature controlled bin is provided for storing sunglasses. That bin includes a sunglasses storage compartment, a temperature regulation device for regulating temperature inside the sunglasses storage compartment and a controller. The controller is configured to receive information respecting at least one operating parameter.

### TECHNICAL FIELD

This document relates generally to the motor vehicle equipment field, and, more particularly, to a temperature controlled bin for storing sunglasses.

### BACKGROUND

This document relates to a new and improved temperature controlled bin for storing sunglasses. In winter weather conditions, the sunglasses are heated in the bin so that when they are removed from the bin and put on by the driver, they are more comfortable and also less likely to fog over with condensation.

It should also be noted that sunglasses storage bins are often provided in the overhead compartment of the vehicle immediately adjacent to the vehicle roof. Sunglasses in such a bin are subjected to substantial radiant heating on hot and sunny summer days. Cooling of the sunglasses in the bin increases driver comfort when they are removed from the bin for use.

### SUMMARY

In accordance with the purposes and benefits described herein, a temperature controlled bin is provided for storing sunglasses. That temperature controlled bin comprises a sunglasses storage compartment, a temperature regulation device for regulating temperature inside the sunglasses storage compartment and a controller. The controller is configured to receive information respecting at least one operating parameter selected from a group consisting of (a) thermal sun load, (b) battery voltage and charge margin and (c) thermal sun load and battery voltage and charge margin.

In one possible embodiment, the temperature regulation device is an electrical resistance heating element. In another possible embodiment, the temperature regulation device comprises a thermoelectric cooler for heating and cooling the sunglasses storage compartment. In still another possible embodiment, the temperature regulation device comprises two thermoelectric coolers for heating and cooling each individual lens of the sunglasses held in the sunglasses storage compartment. In one possible embodiment, the sunglasses storage compartment includes a lining and the temperature regulation device is provided behind the lining. In still another possible embodiment, the sunglasses storage compartment includes a metalized film and the temperature regulation device is provided between the lining and the metalized film.

In yet another possible embodiment the sunglasses bin includes a storage compartment door, and the lining, the metalized film and the temperature regulation device are all provided on this storage compartment door. In still another possible embodiment, the temperature controlled bin is part of an overhead console and the sunglasses storage compartment includes an upper insulated enclosure opposite the temperature regulation device in the storage compartment door.

The controller may be further configured to receive information respecting temperature within the sunglasses storage compartment. Accordingly, in such an embodiment, the temperature controlled bin may also include a sunglasses storage compartment temperature sensor connected to the controller.

In accordance with yet another aspect, a temperature controlled bin for storing sunglasses comprises a sunglasses storage compartment, a thermoelectric cooler for heating or cooling the sunglasses storage compartment and a controller configured to receive information respecting at least one operating parameter and controlling the thermoelectric cooler in response thereto.

In accordance with yet another aspect, a method is provided for heating or cooling the sunglasses storage compartment of a temperature controlled bin. That method may be broadly described as comprising the steps of equipping the sunglasses storage compartment with a thermoelectric cooler for heating and cooling the sunglasses storage compartment and controlling operation of the thermoelectric cooler in response to at least one operating parameter selected from the group consisting of (a) thermal sun load, (b) battery voltage and charge margin, (c) temperature within the sunglasses storage compartment and (d) combinations thereof.

In the following description, there are shown and described several preferred embodiments of the temperature controlled bin. As it should be realized, the temperature controlled bin is capable of other, different embodiments and its several details are capable of modification in various, obvious aspects all without departing from the temperature controlled bin as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the temperature controlled bin and together with the description serve to explain certain principles thereof. In the drawing figures:

FIG. 1 is a schematic cross-sectional view of a temperature controlled bin which is the subject matter of this document.

FIG. 2a is a schematic block diagram of a control system for a first embodiment of the temperature controlled bin.

FIG. 2b is a schematic block diagram of a control circuit for a second embodiment of the temperature controlled bin.

FIG. 3 is a schematic block diagram of the controller which is configured to receive information and control the temperature regulation device of the temperature controlled bin.

Reference will now be made in detail to the present preferred embodiments of the temperature controlled bin, examples of which are illustrated in the accompanying drawing figures.

### DETAILED DESCRIPTION

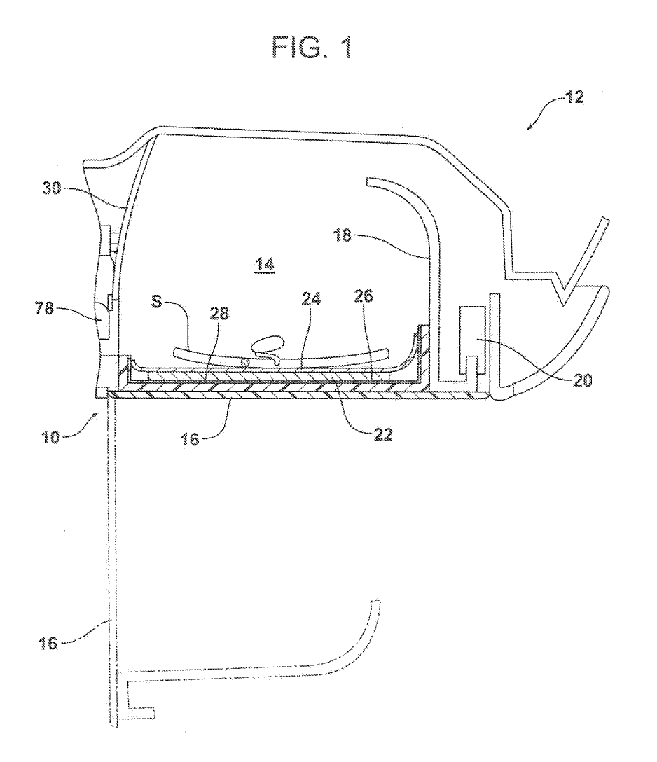

Reference is now made to FIG. 1, illustrating in cross-section the temperature controlled bin 10 for storing sunglasses S that is the subject matter of this document. In the illustrated embodiment, the temperature controlled bin 10 is provided in the overhead console 12 of a motor vehicle. As illustrated, the temperature controlled bin 10 includes a sunglasses storage compartment 14 for holding the sunglasses S. The sunglasses storage compartment includes a pivoting door 16. It includes a cavity or pocket 18 for receiving and holding the sunglasses S. When the door 16 is pivoted open (note phantom line position), the cavity or pocket 18 opens upwardly, so that one may conveniently place the sunglasses S in the cavity or pocket and then pivot the door about the hinges into the closed position where the glasses are held in the storage compartment 14 (note full line position door illustrated in FIG. 1). A latch 20, of a type known in the art, holds the pivoting door 16 in the closed position.

As further illustrated in FIG. 1, the temperature controlled bin 10 also includes a temperature regulation device 22 for regulating the temperature inside the sunglasses storage compartment 14. In the illustrated embodiment, the temperature regulation device 22 is provided on the pivoting door 16. More specifically, the temperature regulation device 22 is provided between an inner lining 24 of felt or other material for receiving and engaging the lenses of the sunglasses S and a metalized film 26 that may be adhered to the inner surface 28 of the pivoting door 16. The metalized film 26 serves to reflect the heat and/or cooling from the temperature regulation device 22 through the inner lining 24 toward the sunglasses S.

As further illustrated in FIG. 1, the temperature controlled bin 10 also includes a layer 30 of insulating material that seals the forward upper portion of the storage compartment 14 so that the compartment and the sunglasses S may be heated and cooled with greater efficiency. While the temperature regulation device 22 is mounted on the door 16 in the illustrated embodiment, it should be appreciated that the temperature regulation device may be provided substantially anywhere in the storage compartment 14 including, for example, in the vehicle forward of or in the vehicle rearward of the sunglasses S held in that compartment. In any embodiment, the temperature regulation device 22 is most effective when it is immediately behind the inner lining 24 that is in contact with the lenses of the sunglasses S.

The temperature regulation device 22 may comprise an electrical resistance heating element, a thermoelectric cooler, a low-voltage heat lamp or the like. A thermoelectric cooler or Peltier cooler is particularly useful as it provides for selective heating and cooling of the sunglasses S, thereby increasing wearer comfort in both the winter and summer.

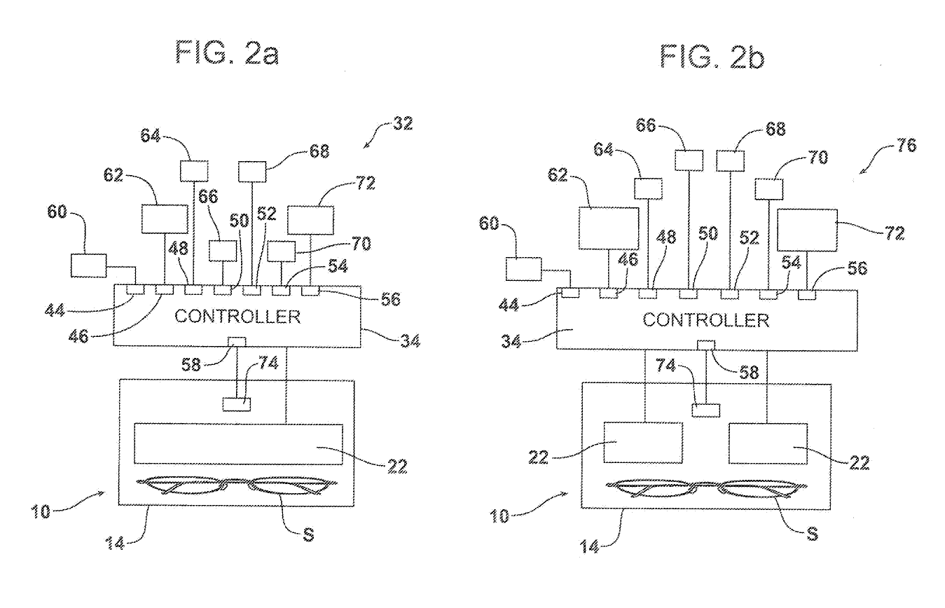

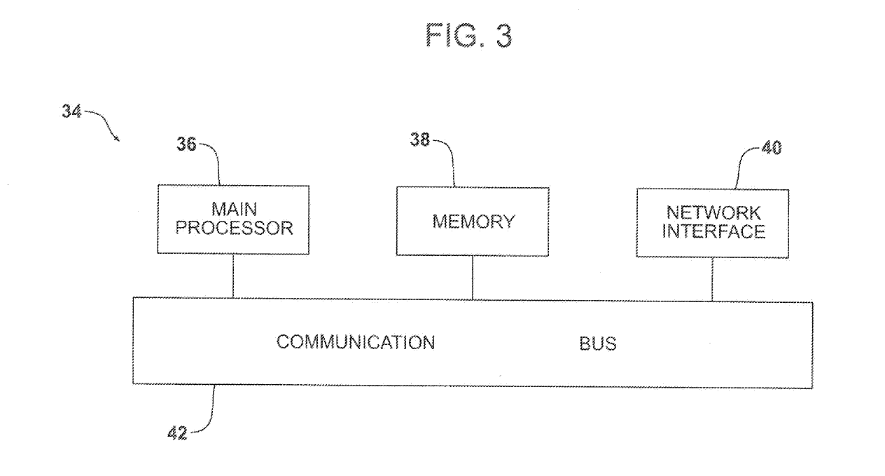

Reference is now made to FIG. 2a, which illustrates a first embodiment of control circuit 32 for the temperature controlled bin 10. That control circuit 32 includes a controller 34 which may take the form of a dedicated microprocessor, an electronic control unit (ECU) or other appropriate computing device running control software for controlling the temperature of the sunglasses storage compartment 14 of the temperature controlled bin 10. As illustrated in FIG. 3, the controller 34 may comprise one or more processors 36, one or more memories 38 and one or more network interfaces 40. All of these components 36, 38, 40 communicate with each other over a communications bus 42.

The controller 34 is configured to receive information respecting at least one operating parameter. In the illustrated embodiment, the controller 34 includes eight inputs 44, 46, 48, 50, 52, 54, 56, 58. Input 44 is connected to a battery voltage and charge margin sensor or other device 60 providing data input respecting battery voltage and charge margin of the motor vehicle V. Input 46 is connected to the ignition, ignition sensor or other device 62 providing data respecting the status of the ignition. Input 48 is connected to a remote start signal receiver or other device 64 indicating when the remote start button on the key fob of the motor vehicle has been activated.

Input 50 is connected to an ambient temperature sensor or other device 66 providing data respecting the ambient temperature. Input 52 is connected to a vehicle interior temperature sensor or other device 68 providing data respecting the interior temperature of the motor vehicle. Input 54 is connected to a thermal sun load sensor or other device 70 providing data respecting the thermal sun load to which the motor vehicle is being subjected on any given day.

Input 56 is connected to a timer or other device 72 providing data respecting the amount of time during which the temperature regulation device 22 has been activated during any given operating cycle. Finally, input 58 is connected to a sunglasses storage compartment temperature sensor or other device 74 providing data respecting the temperature inside the sunglasses storage compartment 14.

The controller 34 operates in response to data provided from the sensors or other devices 60, 62, 64, 66, 68, 70, 72, 74 through the inputs 44, 46, 48, 50, 52, 54, 56, 58 to control the operation of the temperature regulation device 22 and, accordingly, the temperature in the storage compartment 14 of the temperature controlled bin 10. Thus, on a cold winter day, the temperature regulation device 22 operates at the command of the controller 34 to warm the sunglasses S stored in the storage compartment 14 so that when they are removed and worn by the vehicle operator they are at a more comfortable temperature. Further, a warmer temperature reduces or eliminates the risk of fogging often characteristic of cold sunglasses when they are first put on by a driver in winter ambient conditions. In contrast, on a hot summer day, the sunglasses S in the storage compartment 14 are cooled so as to be far more comfortable when first worn. This is a particularly pleasing feature for vehicle operators in warm sunny climates where hot summer days are common and strong radiant heating may be experienced in the sunglasses storage compartment 14 when found in an overhead console 12.

Table 1 below illustrates one control algorithm utilized by the controller 34 to control the temperature regulation device 22 and, thereby, the temperature in the sunglasses storage compartment 14.

TABLE 1

| | | | | | Charge | | |
|---|---|---|---|---|---|---|---|
| | | | Sun | | Margin/ | Bin | |
| | Inside | Outside | Load | Ignition | Bat | Heater | |
| Case | Temp | Temp | Sensor | ON? | Voltage | On/Off | Comment |
| Car | <65 F. | <32 F. | N/A | Yes | Yes | Intermittent | Because it is cold |
| Running | | | | | | heating | outside, store heat in bin |
| | | | | | | | while vehicle has power |
| | | | | | | | to spare |
| Car Not | <32 F. | <32 F. | Night | No | Yes | Time On | Turn on bin heater for a |
| Running | | | | | | | short time every 2 hours |
| | | | | | | | to keep sunglasses above |
| | | | | | | | 50 F. |
| Car Not | <40 F. | N/A | Day | No | N/A | Feature | Sun load on car will |
| Running | | | | | | Disable | keep interior and |
| | | | | | | | sunglass bin warm |
| | | | | | | | enough |
| Car Not | N/A | N/A | N/A | N/A | N/A | Feature | Assumption of long term |
| Running | | | | | | Disable | park |
| for more | | | | | | | |
| than 48 | | | | | | | |
| hours | | | | | | | |

Reference is now made to FIG. 2b, illustrating yet another embodiment of control circuit 76. The control circuit 76, is very similar to the control circuit 32 and, as illustrated, incorporates the same inputs and sensors/devices as previously described and identified by the same reference numbers. The difference between the two circuits 32, 76 rests in a temperature regulation device 22. In the alternative control circuit 76, the temperature regulation device 22 comprises two separate thermoelectric coolers/Peltier coolers 22, one provided for heating and cooling each individual lens of the sunglasses S. In either of the embodiments illustrated in FIGS. 2a and 2b, it should be appreciated that the controller 34 may be provided on a printed circuit board 78. That printed circuit board 78 may be conveniently located in the overhead console 12 directly forward of the sunglasses storage compartment 14 behind the insulating material 30.

In summary, numerous benefits result from employing the concepts disclosed in this document. In summer, sunglasses S stored in the temperature controlled bin 10 may be cooled to a comfortable temperature before being worn by the vehicle operator. In winter, sunglasses S stored in the temperature controlled bin 10 may be warmed prior to wearing to increase wearer comfort and reduce the risk of the sunglass lenses fogging.

Advantageously, the controller is configured to receive various data inputs 44, 46, 48, 50, 52, 54, 56, 58 and more actively and effectively control the temperature regulation device 22 for the storage compartment 14 in response to data received on those inputs. In the illustrated embodiment, inputs include remote start and battery voltage and charge margin which together allow the controller to immediately begin warming the sunglasses on a cold winter day when the motor vehicle is started remotely so long as the battery voltage and charge margin allow without risking a low battery in case vehicle restart becomes necessary. Data with respect to thermal sun load allows the controller to monitor and predict radiant heating of the sunglasses storage compartment 14 due to sunlight on any given day and operates the temperature regulation device 22 accordingly to provide the most effective and efficient functioning of the temperature controlled bin 10.

The foregoing has been presented for purposes of illustration and description. It is not intended to be exhaustive or to limit the embodiments to the precise form disclosed. Obvious modifications and variations are possible in light of the above teachings. For example, the temperature regulation device 22 may comprise an air duct for directing warm or cool air from the HVAC system of the motor vehicle into the sunglasses storage compartment 14 of the temperature controlled bin 10 if desired, instead of the various other devices identified above. All such modifications and variations are within the scope of the appended claims when interpreted in accordance with the breadth to which they are fairly, legally and equitably entitled.

What is claimed:

1. A temperature controlled bin for storing sunglasses, comprising:
a sunglasses storage compartment;
a temperature regulation device for regulating temperature inside said sunglasses storage compartment; and
a controller configured to receive information respecting at least one operating parameter selected from a group consisting of (a) thermal sun load, (b) battery voltage and charge margin and (c) thermal sun load and battery voltage and charge margin.

2. The temperature controlled bin of claim 1, wherein said temperature regulation device is an electrical resistance heating element.

3. The temperature controlled bin of claim 1, wherein said temperature regulation device comprises a thermoelectric cooler for heating and cooling said sunglasses storage compartment.

4. The temperature controlled bin of claim 1, wherein said temperature regulation device comprises two thermoelectric coolers for heating and cooling each lens of sunglasses held in said sunglasses storage compartment.

5. The temperature controlled bin of claim 1, wherein said sunglasses storage compartment includes a lining and said temperature regulation device is provided behind said lining.

6. The temperature controlled bin of claim 5, wherein said sunglasses storage compartment includes a metalized film, said temperature regulation device being provided between said lining and said metalized film.

7. The temperature controlled bin of claim 6, wherein said sunglasses bin includes a storage compartment door and said lining, said metalized film and said temperature regulation device are provided on said storage compartment door.

8. The temperature controlled bin of claim 7, wherein said temperature controlled bin is part of an overhead console and said sunglasses storage compartment includes a sealed upper insulated enclosure opposite said temperature regulation device in said storage compartment door.

9. The temperature controlled bin of claim 8, wherein said temperature regulation device is an electrical resistance heating element.

10. The temperature controlled bin of claim 8, wherein said temperature regulation device comprises a thermoelectric cooler for heating and cooling said sunglasses storage compartment.

11. The temperature controlled bin of claim 8, wherein said temperature regulation device comprises two thermoelectric coolers for heating and cooling each lens of sunglasses held in said sunglasses storage compartment.

12. The temperature controlled bin of claim 11, wherein said controller is further configured to receive information respecting temperature within said sunglasses storage compartment.

13. The temperature controlled bin of claim 12, further including a sunglasses storage compartment temperature sensor connected to said controller.

14. A temperature controlled bin for storing sunglasses, comprising:
a sunglasses storage compartment;
a thermoelectric cooler for heating or cooling said sunglasses storage compartment; and
a controller configured to receive information respecting at least one operating parameter and controlling said thermoelectric cooler in response.

15. The temperature controlled bin of claim 14, wherein said sunglasses storage compartment includes a lining and said temperature regulation device is provided behind said lining.

16. The temperature controlled bin of claim 15, wherein said sunglasses storage compartment includes a metalized film, said temperature regulation device being provided between said lining and said metalized film.

17. The temperature controlled bin of claim 16, wherein said sunglasses bin includes a storage compartment door and said lining, said metalized film and said temperature regulation device are provided on said storage compartment door.

18. The temperature controlled bin of claim 17, wherein said temperature controlled bin is part of an overhead console and said sunglasses storage compartment includes a sealed upper insulated enclosure opposite said temperature regulation device in said storage compartment door.

19. The temperature controlled bin of claim 18, wherein said at least one operating parameter is sunglasses storage compartment temperature and said temperature controlled bin further includes a sunglasses storage compartment temperature sensor.

20. A method of heating or cooling a sunglasses storage compartment of a temperature controlled bin, comprising:
equipping the sunglasses storage compartment with a thermoelectric cooler for heating and cooling said sunglasses storage compartment; and
controlling operation of said thermoelectric cooler in response to at least one operating parameter selected from a group consisting of (a) thermal sun load, (b) battery voltage and charge margin, (c) temperature within said sunglasses storage compartment and (d) combinations thereof.
